(19) United States
(12) Patent Application Publication
(10) Pub. No.: US 2014/0032666 A1
(43) Pub. Date: Jan. 30, 2014

(54) Method and System for Instant Photo Upload with Contextual Data

(71) Applicant: Xtreme Labs Inc., Toronto (CA)

(72) Inventors: Boris Kai-Tik Chan, Toronto (CA); Kok Kik Tong Wong, Toronto (CA); Joshua Winters, Toronto (CA); Gregory Robert Burgoon, Toronto (CA); David Protasowski, Oshawa (CA); Sundeep Singh Madra, Palo Alto, CA (US)

(73) Assignee: Xtreme Labs Inc., Toronto (CA)

(21) Appl. No.: 13/947,618

(22) Filed: Jul. 22, 2013

Related U.S. Application Data
(60) Provisional application No. 61/741,566, filed on Jul. 24, 2012.

(51) Int. Cl. H04L 29/08

(52) U.S. Cl. CPC H04L 67/02
USPC 709/204

(57) ABSTRACT

A method is provided for publishing photographs taken on a mobile device. Sensor data is obtained from at least one sensor in communication with the mobile device with respect to a context of the mobile device or the user. When a photograph is taken by the user, the photograph is automatically uploaded to a predefined profile of the user on a social network. Aspects of the sensor data are also published on the profile as contextual information. The photograph and contextual information are implicitly published and shared in a fully-formed fashion. A programmed mobile device is also provided for carrying out the method.

### CROSS-REFERENCE TO RELATED APPLICATIONS

This application claims the benefit of U.S. Provisional Patent Application No. 61/741,566, filed Jul. 24, 2012 and entitled “System and Method for Instant Photo Upload with Contextual Data”, which is incorporated herein by reference in its entirety.

### FIELD OF INVENTION

The invention relates to uploading photographs from mobile devices and more particularly relates to publication of such photographs on social network profiles.

### BACKGROUND

Although existing mobile devices e.g. phones, smartphones, tablets and the like include cameras and other sensors, taking a photo and uploading it to a website (e.g. a social networking site), is a multi-step process. It requires that a user take a photo using one application, then log on to the social networking site, choose add photo, then select the photo for upload. Adding other contextual data e.g. location, tagging people in the photos etc. requires additional multiple steps. In light of the difficulty, users are also inclined to “curate” the photographs that they do select for uploading and publishing.

The difficulty is that spontaneity is lost and, although photographs are easy to take on mobile devices, the user is not typically able to capture the moment for the user's social network profile as events occur and as the user goes about his/her daily life.

Thus we note that prior art methods have inherent limitations since they pose a considerable challenge in terms of ease of use. Accordingly, there is a need for providing an improved user experience by providing a method and a system for automatic and instantaneous upload of photos along with contextual data.

### SUMMARY

The prior art deficiencies and other problems associated with uploading photos from a mobile device with contextual data are overcome by the disclosed invention. It is an object of the invention to start an instantaneous and automatic upload of photos from a mobile device along with the contextual data as soon as the photo is taken. The user is given an optional opportunity to cancel the upload if they so desire.

In one embodiment of the invention the system and method offer an instantaneous and automatic upload of photos to social network e.g. Facebook, along with the contextual data e.g. location, date and time, tagging the faces that are recognized in the photo, etc. as soon as the photo is taken by the user. Optionally the user has the ability to cancel the upload by providing an input for example swiping across the touch screen.

Instructions for performing these functions may be included in a computer readable storage medium or other computer program product configured for execution by one or more processors on the said device.

This in turn improves user interaction and provides a new and unique way of faster uploading of photos along with the contextual data with minimal user interaction required.

According to an aspect of the invention, a method is provided for publishing photographs taken on a mobile device. Sensor data is obtained from at least one sensor in communication with the mobile device. The sensor data is with respect to a context of the mobile device or the user. A photograph is taken by the user using a camera on the mobile device. With this input alone, and automatically and without further affirmative action by the user, the photograph is uploaded by the device to a predefined profile of the user on a social network. Further, automatically and without further affirmative action by the user, certain predefined aspects of the sensor data are also published as contextual information with the photograph on the profile on the social network. Thus, the photograph is immediately uploaded and shared without the hassle of selection, editing and curating beforehand.

The photograph and contextual information are implicitly published and shared in a fully-formed fashion. That is, the user does not have to select or edit the photograph, or supply or edit the contextual information. Both are fully-formed and publication-ready immediately, and this occurs automatically. These are published and shared as an implicit process. This allows the user freedom and spontaneity for capturing moments as they occur, thus creating a chronicle of the user's life as it unfolds, without the user needing to take specific time and steps to “scrapbook” past photographs and recall the time, place and context in which they occurred (which may be easily lost or forgotten).

Although automatic uploading and publication are default in the method, a cancellation option may also be provided at the uploading or publishing step. The cancellation option is preferably actuatable from the mobile device. For example, the cancellation option may be actuated by a single gesture on the mobile device (including gesture on a touch-screen or other simple inputs such as pressing a button, or providing a voice input). The uploaded photograph may also be deleted after the fact, or there may be an auto-delay or undo period.

Preferably, the sensor data comprises at least one of geo-location, time, date, camera settings, compass bearing, speed or acceleration of device, orientation of device, elevation, heart rate of user, temperature, humidity, pressure, light reading, proximity to another device or tag.

The sensor may be an onboard sensor (or other sensor in communication with the device).

Preferably, the at least one sensor includes a sensor selected from the group consisting of: GPS, clock, calendar, camera or other device settings, compass, accelerometer, gyroscope, altimeter, heart rate monitor, thermometer, humidity sensor, pressure sensor, light sensor, proximity sensor.

The method may also include filtering the sensor data using an external service before or after uploading. This may involve matching sensor data to related contextual information in a database. For example, contents of the photograph may be matched to known images in a database. Where the content comprises a person in the photograph, the person may be matched to images of known persons in the user's social graph. The identity and relationship of the matched person to the user may also be retrieved from the user's social graph.

The content may also or in the alternative comprise an object, and the matching step may further comprise matching the object to images of known objects in the database. For example, the object may be a geographical landmark that can be matched with known images of the landmark to identify it.

Preferably, the photograph and the contextual information are automatically published on a timeline in chronological order with other photographs.

The photograph may be automatically published with date and time information as to when the photograph was taken. The photograph may be automatically published with location information as to where the photograph was taken. This location information may be linked to a map of where the photograph was taken.

In one embodiment, the contextual information may be appended to the photograph as one or more tags. Information from the content matching may also be appended to the photograph as one or more tags.

In one embodiment, the sensor data is obtained and filtered continuously until the photograph is taken to allow the contextual information to be ready for immediate upload with the photograph.

According to another aspect of the invention, a programmed mobile device is provided for publishing photographs taken on the mobile device. The mobile device is programmed for obtaining sensor data from at least one sensor in communication with the mobile device with respect to a context of the mobile device or the user. Then, when a photograph is taken using the mobile device, the photograph is automatically and without further affirmative action by the user uploaded to a predefined profile of the user on a social network. Predefined aspects of the sensor data are also published automatically and without further affirmative action by the user as contextual information with the photograph on the profile on the social network.

The user's social network profile is preferably at least temporarily stored on the mobile device. The user's social network profile is preferably at least temporarily displayed on the mobile device. The user's social graph may also be retrieved and at least temporarily stored on the mobile device to permit matching.

### BRIEF DESCRIPTION OF THE FIGURES

FIG. 1 is a flow diagram illustrating the primary steps of the method, according to a preferred embodiment.

FIG. 2 is a flow diagram representing an example of sensor data gathering and filtering to provide contextual information to accompany a photograph.

FIG. 3 is a conceptual diagram of a simple embodiment of the invention, in this case using a mobile device camera to take a photograph of two people in a park, which is immediately uploaded and published on a social media network page with contextual information.

### DETAILED DESCRIPTION

Before embodiments of the invention are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages. Additionally computer code may also be written using a web programming stack of software, which may mainly be comprised of open source software, usually containing an operating system, Web server, database server, and programming language. LAMP (Linux, Apache, MySQL and PHP) is an example of a well-known open-source Web development platform. Other examples of environments and frameworks using which computer code may also be generated are Ruby on Rails which is based on the Ruby programming language, or node.js which is an event-driven server-side JavaScript environment.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A device that enables a user to engage with an application using the invention, including a memory for storing a control program and data, and a processor (CPU) for executing the control program and for managing the data, which includes user data resident in the memory and includes buffered content. The computer may be coupled to a video display such as a television, monitor, or other type of visual display while other devices may have it incorporated in them (iPad). An application or a game or other simulation may be stored on a storage media such as a DVD, a CD, flash memory, USB memory or other type of memory media or it may be downloaded from the interne. The storage media can be inserted to the console where it is read. The console can then read program instructions stored on the storage media and present a user interface to the user.

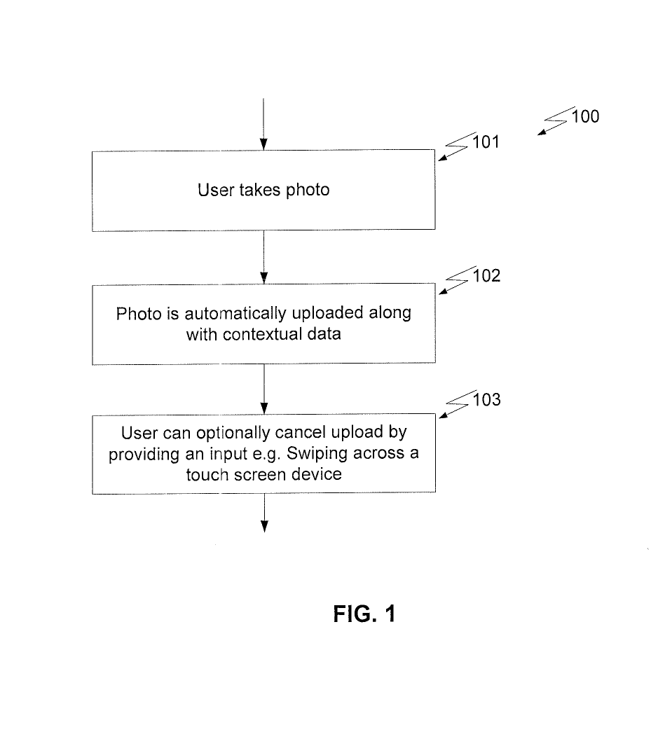

FIG. 1 shows a flow diagram of primary steps in the method. The user takes a photo 101. In the preferred embodiment of the invention the system and method may be implemented on a smartphone, as most mobile devices at present incorporate a camera in them along with a multitude of in-built sensors. Devices where invention can be advantageously implemented may include but not limited to an iPhone, iPad, Smartphones, Android phones, RIM Blackberry devices, personal computers e.g. laptops, tablet computers, touch-screen computers running any number of different operating systems e.g. MS Windows, Apple iOS, Linux, Ubuntu, etc.

This photograph is automatically and instantaneously uploaded to the social network of the user's choice together with contextual data 102. A social networking service is an online service or a platform or a website that provides the means for people to build their social networks reflecting their social relationships with other people. Typically a social network service consists of a representation of each person via a profile, each person's social connections and their interests. Today most social networking services are web-based and also provide means for people to interact with each other through e-mail, instant messaging, online chats etc. Social networking websites allow people to share ideas, activities, events, and interests within their individual networks.

Facebook, Twitter, LinkedIn and Google+ are examples the most popular social networking websites. Social networking websites share a variety of technical features. The most basic of these are visible profiles usually with a list of “friends” who are also users of the site. Some social networking websites allow people to upload pictures, add multimedia content to uniquely individualize the look and feel of their profiles. Facebook even allows people to enhance their profiles by adding modules or applications.

Profiles often have a section dedicated to comments from friends and other users. To protect user privacy, social networks typically have controls that allow users to choose who can view their profile, contact them, add them to their list of contacts, and so on.

Contextual data includes but is not limited to e.g. geo-location, time and date, camera settings, subject(s), people in the photo, etc. This list is exemplary and not limiting, in fact this list may include all or any of the other items that are obvious to those familiar with the art.

Optionally, the user has the ability to cancel the upload by providing an input, for example by swiping across a touch screen of a mobile device 103. There may be other methods of providing input for cancelling the upload e.g. using voice, pressing a cancel button, etc.

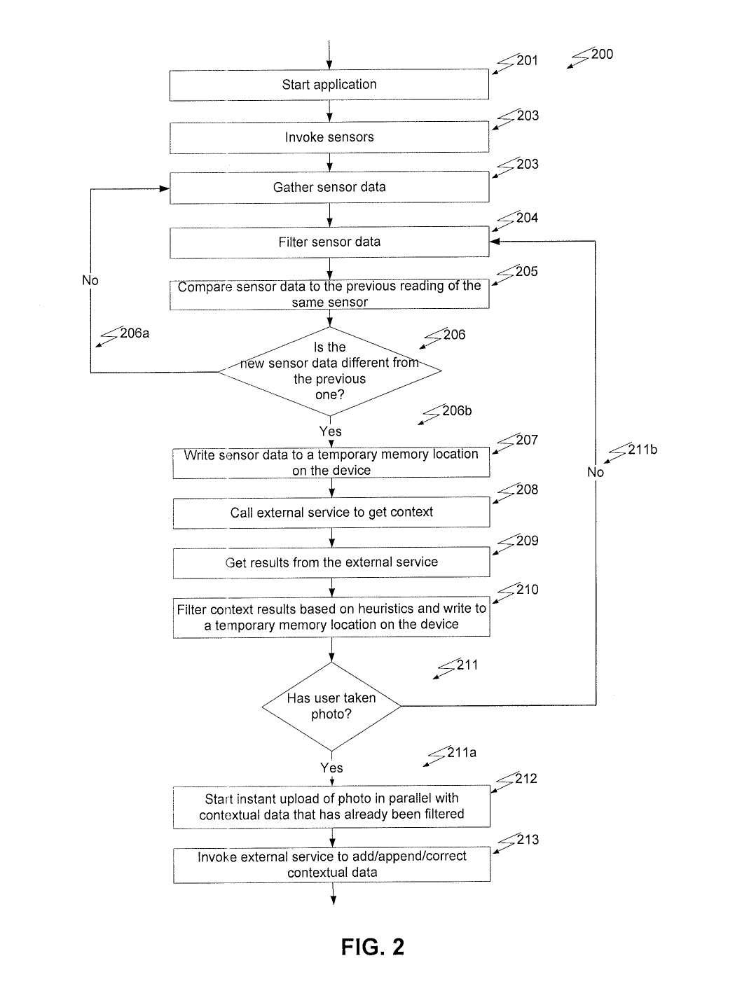

FIG. 2 shows an example of flow of sensor data gathering and filtering to provide contextual information to accompany a photograph. To begin, the user starts the application 201 (or it may be automatically invoked whenever the device is turned on or when the camera application is open/active. Either the user can manually start the application or the application may be started by another process or trigger. The application for taking photos may be a standalone application or this functionality may be embedded in another application that can make use of the camera and the embedded sensors in the device.

Sensors on the device (or in communication with the device) are invoked 202. Smartphones and other mobile devices like tablets have several in-built sensors in them. Various sensors available on mobile devices are briefly discussed below.

Micro-Electro-Mechanical Systems (MEMS) is the integration of mechanical elements, sensors, actuators, and electronics on a common silicon substrate through micro-fabrication technology. In essence MEMS are tiny mechanical devices that are built onto semiconductor chips and are measured in micrometers. While the electronics are fabricated using integrated circuit process sequences the micromechanical components are fabricated using compatible “micromachining” processes. Complete systems-on-a-chip MEMS are an enabling technology allowing the development of smart products, augmenting the computational ability of microelectronics with the perception and control capabilities of micro-sensors and micro-actuators.

### Digital Compass

An electro-magnetic device that detects the magnitude and direction of the earth's magnetic field and point to the earth's magnetic north. Used to determine initial state (players facing each other), and then to determine ground-plane orientation during play.

### Accelerometer

Used for corroborating the compass when possible, and for determining the up-down plane orientation during play. In an AR game compass and accelerometer provide directionality.

### Gyroscope

A gyroscope is a device for measuring or maintaining orientation, based on the principles of conservation of angular momentum. Gyroscopes can be mechanical or based on other operating principles, such as the electronic, microchip-packaged MEMS gyroscope devices found in consumer electronic devices. Gyroscopes include navigation when magnetic compasses do not work, or for the stabilization, or to maintain direction.

### Altimeter

An altimeter is a device for determining elevation changes. An altimeter may also determine what floor a person is on inside a building—potentially useful data for first-responders relying on location data to find a person in need of medical attention.

### Heart-Rate Monitors

Heart-rate monitors for measuring the heart rate of the user to measure the excitement level and the mood. For example photos taken on a roller-coaster may show elevated heart rates to determine the heightened excitement of the user while or immediately after the ride.

### Other Sensors

Other sensors that may include sensors to detect perspiration; temperature and humidity sensors for gathering more user or environmental data; ambient light sensor; proximity sensor; pressure sensor (e.g. air pressure or blood pressure); etc.

Sensor data is gathered 203. This application discloses methods and systems that use some of the above listed embedded sensors in a mobile device to implement the instantaneous and automatic upload of photos along with relevant contextual data that is pertinent to the photo.

In some embodiments of the invention the sensors may also be embedded in other items for example the user's clothing, shoes, immediate surroundings and can interact with the mobile device by providing relevant information that can make the photos more meaningful.

The sensor data is filtered 204. Some examples of sensor data filtering include filtering out noise in an image or audio recording, waiting for the data to stabilize (i.e. image/camera not moving), waiting for the location information to become more accurate etc.

The current sensor data (readings) may also be compared to any previous set(s) of sensor data 205. The system checks/compares to identify if the new sensor data is different from the previous readings of the same sensors 206.

If the new sensor readings are not different from the previous readings 206a, then the system continues to gather sensor data 203.

If the new sensor readings are different from the previous readings of the same sensor 206b, then the system writes the new sensor data to a temporary memory location on the device 207. The sensor data is stored in a temporary memory location or in a local database or other local data storage e.g. a file. The local data storage is such that it is easily accessible by other applications installed on a device. This may be achieved by providing an API to this aggregated information so that other applications may also easily access this information.

An external service may be called to get the contextual data/information to supplement or filter the raw data that was detected by the sensors 208. For example, the system may call Google Maps for location, Facebook for the user's friends list etc. Some examples of external services are a reverse geo-code from a latitude/longitude to location (e.g. city, state), using either Google or local phone API e.g. iOS API or Android API.

Another example is to use latitude/longitude to return a list of nearest venues preferably using Foursquare or Facebook.

Another example is to upload a photo to run facial recognition and return a list of friends for tagging using Facebook. There are various ways to run efficient facial recognition algorithms to generate approximate matches from a closed set. Some examples are set out below.

Face detection is a computer technology that determines the locations and sizes of human faces in digital images. Face detection can be regarded as a specific case of object-class detection. In object-class detection, the task is to find the locations and sizes of all objects in an image that belong to a given class; examples include faces, upper torsos, pedestrians, buildings, cars etc.

OpenCV (Open Source Computer Vision Library) is a cross-platform compatible library of programming functions aimed at real-time computer vision and it focuses mainly on real-time image processing. OpenCV is widely implemented as a method of choice for face recognition.

Another method of face recognition is disclosed in U.S. Pat. No. 7,953,278 “Face recognition method and apparatus”, the disclosure of which is incorporated by reference.

Face recognition could also be done using a web-service, for example, using an API exposed by a server side implementation of the facial recognition technology. As an example such a service may be offered by Facebook.com who acquired Face.com.

The results from the external service(s) are retrieved to provide the contextual data 209. The contextual data results can be filtered based on heuristics. This data can then be written to a temporary memory location on the device 210. Heuristics refers to experience-based techniques for problem solving, learning, and discovery. Where an exhaustive search is impractical, heuristic methods are used to speed up the process of finding a satisfactory solution. Examples of this method include using a rule of thumb, intuitive judgement, educated guess, and or common sense. Heuristics provide strategies using readily accessible, though loosely applicable, information to control problem solving.

In computer science a heuristic is a technique designed to solve a problem that ignores whether the solution can be proven to be correct, but which usually produces a good solution or solves a simpler problem that contains or intersects with the solution of the more complex problem. Heuristics are intended to gain computational performance or conceptual simplicity, though potentially at the cost of accuracy or precision. Each successive iteration depends upon the step before it, thus the heuristic search learns what avenues to pursue and which ones to disregard by measuring how close the current iteration is to the solution. A heuristic method can accomplish its task by using search trees. However, instead of generating all possible solution branches, a heuristic selects branches more likely to produce outcomes than other branches. It is selective at each decision point, picking branches that are more likely to produce solutions.

Some examples of contextual data and their filtering based on heuristics include but are not limited to getting a list of venues back and picking the one that is the closest to the user.

Another example is the use of a facial recognition technology whereby the system of the invention receives a list of potential friends/people—and chooses the one(s) with the highest likeness to the ones in the video frame.

The system checks to see if the user has taken a photo 211. If the user has not taken a photo (211b), then the system continues to gather and filter sensor data 203.

If the user has taken a photo (211a), then the system starts instant and automatic upload of said photo along with the contextual data 212 that has already been filtered and written to the temporary memory location. The pre-gathering and filtering of sensor data allows the upload of the photograph to proceed automatically and without delay. The upload proceeds without input or specific positive commands, authorization or editing from the user.

External service(s) are then invoked to add/append/correct the contextual data 213.

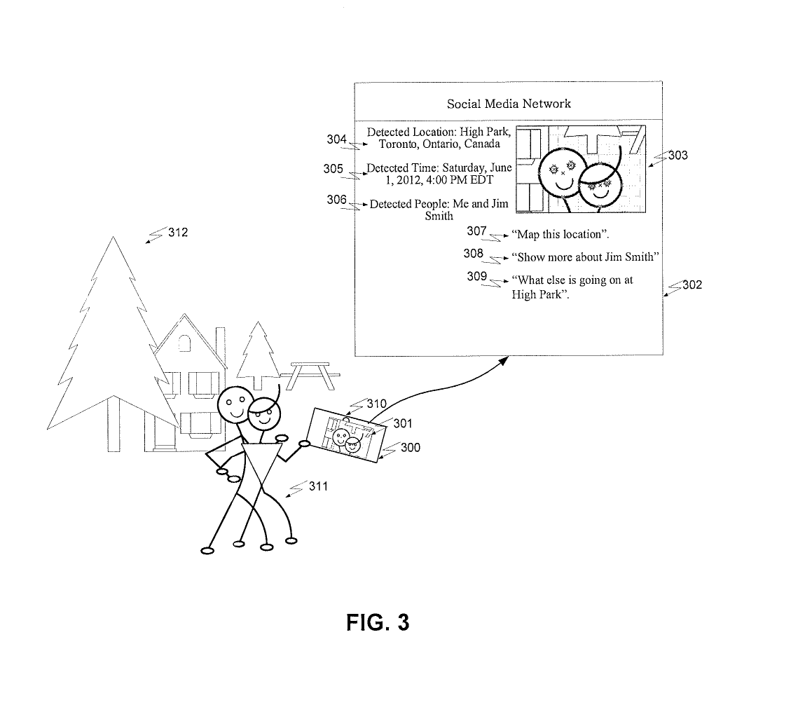

FIG. 3 shows a conceptual diagram of a simple example of the process. Using camera 310 on device 300, user takes a photograph 301 of two persons 311 at a location 312. The photograph 301 is automatically uploaded to the user's social media network page 302 where it is published at 303 with some contextual information that is automatically gleaned from sensor data which is matched and filtered using external databases. For example, using the device's onboard time and date function, the time and date of the photograph are displayed at 305 (“Saturday, Jun. 1, 2012, 4:00 PM EDT”). The location (gleaned from GPS geo-location, matched with related databases) is determined to be “High Park, Toronto, Ontario, Canada”, which is published at 304. The location information is also linked in the example with further information (a map option at 307, and “What else is going on at High Park” at 309). The content of the photograph can also be analysed. In this case, the images of the people in the photograph are also matched with existing images (here, matching the female person to the user/owner of the social network profile, and the user's friend “Jim Smith”). Jim Smith can be identified by matching his photograph to other photographs of Jim Smith linked to the profile of the user through the user's social graph. The detected people is thus shown at 306 as “Me and Jim Smith”. The option is also provided at 308 to “Show more about Jim Smith”. This could link, for example, to Jim Smith's user profile on the same social network, or other information (e.g. other photographs of Jim Smith, events featuring Jim Smith on the user's calendar or chronology, etc.). The location 312 may also be parsed in the photograph if there are identifiable landmarks or venues, for example.

In one embodiment of the invention a social networking website provides a social graph; for example Facebook offers a social graph that represents people and the connections they have to other people or things that they may care about. Facebook offers a well documented and established API, the Graph API, which presents a simple, consistent view of the Facebook social graph, uniformly representing objects in the graph (e.g., people, photos, events, and pages) and the connections between them (e.g., friend relationships, shared content, and photo tags). The Graph API as such allows a developer/application to access all public information about an object. The Graph API allows an application to read properties and connections of the Facebook social graph. A developer can use the API to read specific fields, get pictures of any object, introspect an object for metadata and get real-time updates on any changes.

With the recent rise and proliferation of social networks, the social graph comes into the spotlight. In mathematics a graph is an abstraction for modeling relationships between things. A graph consists of nodes and edges, or things and the ways that these things relate to each other. A social graph is a representation of the interconnection of relationships in an online social network. A social graph is a mapping of people and how they are related or connected to other people. In a social graph, each person is a node. There is an explicit connection, if two people know each other, for example, two people can be connected because they work together or because they went to school together or because they are married. The links between people in social networks are of different types; and the different types of relationships can be a friend, a co-worker, a family member, a classmate, a schoolmate etc.

There may be at least two kinds of relationships; one-way relationships and two-way relationships. An example of a one-way relationship is a person subscribing or following a celebrity. In this kind of relationships one the person subscribing or following needs to start the relationship. An example of a two-way relationship is a person sending a “friend” request to another person, and the second person then confirming the “friend” request before the relationship is established. Thus in a two-way relationship if the recipient of the “friend” request does not confirm this request there is no relationship between the two people in the social graph.

To get this context sensitive information about a user that is not publically available, a developer/application must first get their permission. To get this private information that is not publically available, an application must get an access token for the Facebook user. After obtaining the access token for the user, the application can perform authorized requests on behalf of that user by including the access token in the Graph API requests.

Every object in the social graph has a unique ID. A developer can access the properties of an object by sending a secure request using the URL https://graph.facebook.com/ID. Additionally, people and pages with usernames can be accessed using their username as an ID. All responses to these requests are sent as JSON objects.

All of the objects in the Facebook social graph are connected to each other via relationships. A developer can examine the connections between objects using the URL structure https://graph.facebook.com/ID/CONNECTION_TYPE.

The Facebook Query Language (FQL) object enables running FQL queries using the Graph API. Facebook Query Language enables a developer to use an SQL-style interface to query the data exposed by the Graph API. It provides for some advanced features not available in the Graph API, including batching multiple queries into a single call.

friendlist
Query this table to return any friend lists owned by the specified user.
friendlist_member
Query this table to determine which users are members of a friend list.

In some embodiments, the device is portable. In some embodiments, the device has a touch-sensitive display with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. In some embodiments, the functions may include providing maps and directions, telephoning, video conferencing, e-mailing, instant messaging, blogging, digital photographing, digital videoing, web browsing, digital music playing, and/or digital video playing. Instructions for performing these functions may be included in a computer readable storage medium or other computer program product configured for execution by one or more processors.

The logic of how people are related to each other may be derived from the social graph of the user. In one embodiment when the explicit relationship information may not be available from the social graph such information may be inferred from other information that may be available. For example the persons who may share the same domain in their e-mail addresses may be considered as colleague when such domain is not one provided by the free e-mail providers for example google.com or yahoo.com etc.

Relationships like family, friend, close friend, acquaintance etc. are inferred from the social graph, by association with a list, group or circle in a social graph, by presence on specific address book contact lists, and filtering can start/end with time and other means e.g. specific events like long weekend, holidays, birthdays etc.

The above sets are exemplary and not limiting and other embodiments of the invention may use any other relationships to categorize these sets of device event information.

Facebook Platform uses the OAuth 2.0 protocol for authentication and authorization and supports two different OAuth 2.0 flows for user login: server-side (also known as the authentication code flow) and client-side (also known as the implicit flow). The server-side flow is used whenever an application needs to call the Graph API from its web server. The client-side flow is used whenever an application needs to make calls to the Graph API from a client, such as JavaScript running in a Web browser or from a native mobile or desktop application.

By default, the user is asked to authorize the application to access basic information that is available publicly or by default on Facebook. If an application needs more than this basic information to function, it must request specific permissions from the user. This is accomplished by adding a scope parameter to the OAuth Dialog request followed by comma separated list of the required permissions.

An application can access people and pages with usernames, where their username is an ID. Getting an access token for a user with no extended permissions allows an application to access the information that the user has made available to everyone on Facebook. If an application needs specific information about a user, like their email address or work history, it must ask for the specific extended permissions. The reference documentation for each Graph API object contains details about the permissions an application needs to access each connection and property on that object.

With a valid access token an application can invoke the Graph API by appending the access_token parameter to Graph API requests. If the user changes their password, the access token expires. An application can request a new access token by re-running the appropriate process.

It should be understood that although the term application has been used as an example in this disclosure but in essence the term may also imply to any other piece of software code where the embodiments of the invention are incorporated. The software application can be implemented in a standalone configuration or in combination with other software programs and is not limited to any particular operating system or programming paradigm described here. Thus, this invention intends to cover all applications and user interactions described above as well as those obvious to the ones skilled in the art.

The computer program comprises: a computer usable medium having computer usable program code, the computer usable program code comprises: computer usable program code for presenting graphically to the users options for scrolling via the touch-screen interface.

Several exemplary embodiments/implementations of the invention have been included in this disclosure. There may be other methods obvious to the ones skilled in the art, and the intent is to cover all such scenarios. The application is not limited to the cited examples, but the intent is to cover all such areas that may be benefit from this invention.

The device may include but not limited to a personal computer (PC), which may include but not limited to a home PC, corporate PC, a Server, a laptop, a Netbook, a Mac, a cellular phone, a Smartphone, a PDA, an iPhone, an iPad, an iPod, an iPad, a PVR, a settop box, wireless enabled Blu-ray player, a TV, a SmartTV, wireless enabled Internet radio, e-book readers e.g. Kindle or Kindle DX, Nook, etc. and other such devices that may be used for the viewing and consumption of content whether the content is local, is generated on demand, is downloaded from a remote server where is exists already or is generated as a result. Source Device where content is located or generated and Recipient Device where content is consumed may be running any number of different operating systems as diverse as Microsoft Windows family, MacOS, iOS, any variation of Google Android, any variation of Linux or Unix, PalmOS, Symbian OS, Ubuntu or such operating systems used for such devices available in the market today or the ones that will become available as a result of the advancements made in such industries.

The intent of the application is to cover all such combinations and permutations not listed here but that are obvious to the ones skilled in the art. The above examples are not intended to be limiting, but are illustrative and exemplary.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to those familiar with the art.

As can be seen from the above descriptions, the invention provides a system and method for the automatic and instantaneous upload of photos from a mobile device along with relevant contextual data to provide more efficient and convenient way of interacting with these devices.

What is claimed is:

1. A method of publishing photographs taken on a mobile device, comprising:
obtaining sensor data from at least one sensor in communication with the mobile device with respect to a context of the mobile device or the user;
receiving input of a photograph being taken by the user using a camera on the mobile device;
automatically and without further affirmative action by the user, uploading the photograph to a predefined profile of the user on a social network; and
automatically and without further affirmative action by the user, publishing predefined aspects of the sensor data as contextual information with the photograph on the profile on the social network.

2. The method of claim 1, further comprising providing a cancellation option at the uploading or publishing step.

3. The method of claim 2, wherein the cancellation option can be actuated from the mobile device.

4. The method of claim 3, wherein the cancellation option can be actuated by a single gesture on the mobile device.

5. The method of claim 1, wherein the sensor data comprises at least one of geo-location, time, date, camera settings, compass bearing, speed or acceleration of device, orientation of device, elevation, heart rate of user, temperature, humidity, pressure, light reading, proximity to another device or tag.

6. The method of claim 1, wherein the sensor is an onboard sensor.

7. The method of claim 1, wherein the at least one sensor includes a sensor selected from the group consisting of: GPS, clock, calendar, camera or other device settings, compass, accelerometer, gyroscope, altimeter, heart rate monitor, thermometer, humidity sensor, pressure sensor, light sensor, proximity sensor.

8. The method of claim 1, further comprising filtering the sensor data using an external service before or after uploading.

9. The method of claim 8, wherein the filtering step comprises matching sensor data to related contextual information in a database.

10. The method of claim 1, further comprising matching content of the photograph to known images in a database.

11. The method of claim 10, wherein the content comprises a person in the photograph and the matching step comprises matching the person to images of known persons in the user's social graph.

12. The method of claim 11, wherein the filtering step further comprises identifying the relationship of the matched person to the user based on the user's social graph.

13. The method of claim 10, wherein the content comprises an object, and the matching step further comprises matching the object to images of known objects in the database.

14. The method of claim 13, wherein the object is a geographical landmark.

15. The method of claim 1, wherein the photograph and the contextual information are automatically published on a timeline in chronological order with other photographs.

16. The method of claim 1, wherein the photograph is automatically published with date and time information as to when the photograph was taken.

17. The method claim 1, wherein the photograph is automatically published with location information as to where the photograph was taken.

18. The method of claim 17, wherein the location information is linked to a map of where the photograph was taken.

19. The method of claim 1, wherein the contextual information is appended to the photograph as one or more tags.

20. The method of claim 10, wherein information from the content matching is appended to the photograph as one or more tags.

21. The method of claim 1, wherein sensor data is obtained and filtered continuously until the photograph is taken such that the contextual information is ready for immediate upload with the photograph.

22. The method of claim 1, wherein the photograph and contextual information are implicitly published and shared in a fully-formed fashion.

23. A programmed mobile device for publishing photographs taken on the mobile device, comprising:
obtaining sensor data from at least one sensor in communication with the mobile device with respect to a context of the mobile device or the user;
receiving input of a photograph being taken by the user using a camera on the mobile device;
automatically and without further affirmative action by the user, uploading the photograph to a predefined profile of the user on a social network; and
automatically and without further affirmative action by the user, publishing predefined aspects of the sensor data as contextual information with the photograph on the profile on the social network.

24. The device of claim 23, wherein the user's social network profile is at least temporarily stored on the mobile device.

25. The device of claim 23, wherein the user's social network profile is at least temporarily displayed on the mobile device.
